(19) United States
(12) Patent Application Publication
(10) Pub. No.: US 2009/0322226 A1
(43) Pub. Date: Dec. 31, 2009

(54) High-pressure discharge lamp

(76) Inventors: Ulrich Henger, Eichenau (DE); Andreas Kloss, Neublberg (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/309,257

(22) PCT Filed: Jul. 28, 2006
(86) PCT No.: PCT/EP2006/007501

§ 371 Date: Jan. 12, 2009

(51) Int. Cl. H01J 7/44

(52) U.S. Cl. 315/56

(57) ABSTRACT

High-pressure discharge lamp, with an outer bulb (10), on which a first terminal (12) and a second terminal (14) are provided, and with a discharge vessel (16), which is accommodated in the outer bulb (10), with a first and a second terminal (18, 20) and with an ignition apparatus (22), which is accommodated in the outer bulb (10) and is connected between the first terminal (12) of the outer bulb and the first terminal (18) of the discharge vessel (16). A switch (32), which closes depending on temperature, is connected in parallel with the ignition apparatus (22) between the first terminal (12) of the outer bulb (10) and the first terminal (18) of the discharge vessel (16). During operation of the lamp, the current therefore flows past the spiral pulse generator (32), so that no power is lost.

### TECHNICAL FIELD

The invention relates to a high-pressure discharge lamp as claimed in the preamble of patent claim 1. It also relates to a method for driving a high-pressure discharge lamp as claimed in the preamble of patent claim 5.

### PRIOR ART

Such a high-pressure discharge lamp and such a method are described in DE 10 2005 061 832 published after the filing date of the present application. FIG. 1 shows, schematically, the most important components of such a high-pressure discharge lamp. A lamp outer bulb, which is given the overall designation 10, is illustrated symbolically by means of a dash-dotted contour. On the outer bulb there is a first connection 12 and a second connection 14. The second connection 14 is connected to ground, for example. At the heart of the lamp there is a discharge vessel 16 with a first connection 18 and a second connection 20 in the lamp outer bulb 10, said second connection 20 likewise being connected to ground. A spiral pulse generator 22 is interposed between the first connection 12 of the lamp outer bulb 10 and the first connection 18 of the discharge vessel. “Interposed” is in this case understood to mean that a possible current flows via a first line path 24 of the spiral pulse generator, while the second line path 26 is not connected to the discharge vessel. The first line path 24 and the second line path 26 can be bridged with the aid of a short-circuiting switch 28. The second line path 26 is connected to ground via a charging resistor 30.

The spiral pulse generator 22 is used for igniting the active gas located in the discharge vessel 16. After the ignition, a current predetermined by the external circuitry of the lamp flows through the discharge vessel 16 and therefore from the first connection 12 of the lamp outer bulb 10 to the second connection 14, i.e. in particular via the interposed voltage generator 22 or, more precisely, via the first line path 24 of the spiral pulse generator 22. As a result of the internal resistance of the spiral pulse generator 22, there is therefore a voltage drop across the spiral pulse generator 22. Thus, electrical power is converted into heat in the spiral pulse generator 22 during normal lamp operation, in addition to the heat generated by the discharge vessel. This power is lost for the lamp, with the result that the system efficiency is correspondingly reduced. The generator is additionally heated, with the result that its life is shortened.

### DESCRIPTION OF THE INVENTION

The object of the invention is to overcome the mentioned disadvantages which the high-pressure discharge lamp as claimed in the preamble of patent claim 1 has as described with reference to FIG. 1 and in particular to provide a high-pressure discharge lamp with good ignition performance, in which some of the power is not lost as a result of the interposition of a spiral pulse generator. The object is achieved by a high-pressure discharge lamp having the features as claimed in patent claim 1 and a method having the features as claimed in patent claim 5.

According to the invention, a switch which closes as a function of temperature is connected in parallel with the ignition apparatus between the first connection of the outer bulb and the first connection of the discharge vessel. Since the discharge vessel 16 is heated to a considerable extent during operation—shortly after ignition a value of 500° C., for example, is reached at the base of the discharge vessel—the switch is therefore closed during operation and the ignition apparatus is bridged. The disadvantage that a voltage drop occurs across the ignition apparatus and thus power is lost is thus eliminated. The invention is not dependent on the ignition apparatus used; a spiral pulse generator is preferably used.

The temperature-dependent switch is preferably a bimetallic switch. A bimetallic, switch has the advantage that it also opens again as a function of temperature. Thus, a further disadvantage of the prior art resulting from the fact that a heated discharge vessel requires a higher ignition voltage is also overcome. Often, after prolonged operation, the discharge vessel is heated to such an extent that if it is switched off and switched on again after a short period of time it cannot immediately reignite. A corresponding ignition apparatus then only applies voltages which are too low. When using the bimetallic switch, the ignition apparatus remains bridged, even if the lamp is switched off, until the discharge vessel has cooled down to a sufficient extent. The ignition apparatus is therefore not activated in vain in the case of the lamp being switched on again, but remains inactive.

A suitable closing temperature, i.e. the temperature at which the switch closes once the temperature has increased, is between 70° C. and 500° C., preferably between 90° C. and 350° C. The lower limit is primarily determined on the basis of typical temperatures which can prevail in the case of given environmental influences in the lamp outer bulb; it should be at least 10° to 15° above these temperatures. A possible upper value for the closing temperature results from the proximity of, the switch, which closes as a function of temperature, to the discharge vessel and the desired switchover speed, to be precise both as far as closing and reopening is concerned.

The method according to the invention for driving a high-pressure discharge lamp in which ignition takes place by means of an ignition apparatus, which is arranged, together with a discharge vessel, in an outer bulb of the high-pressure discharge lamp is characterized in that, after the ignition, a switch is activated which guides the current required for operation of the high-pressure discharge lamp past the ignition apparatus. The switch is preferably activated thermally. The method can be further developed by the use of the high-pressure discharge lamp in the embodiments previously mentioned.

### BRIEF DESCRIPTION OF THE DRAWING

A preferred embodiment of the invention will be described below with reference to the drawing, in which:

FIG. 1 shows, schematically, the essential components of a high-pressure discharge lamp of the (subsequently published) prior art, on which the invention is based, and

FIG. 2 shows, schematically, the essential components of a high-pressure discharge lamp according to the invention.

### PREFERRED EMBODIMENT OF THE INVENTION

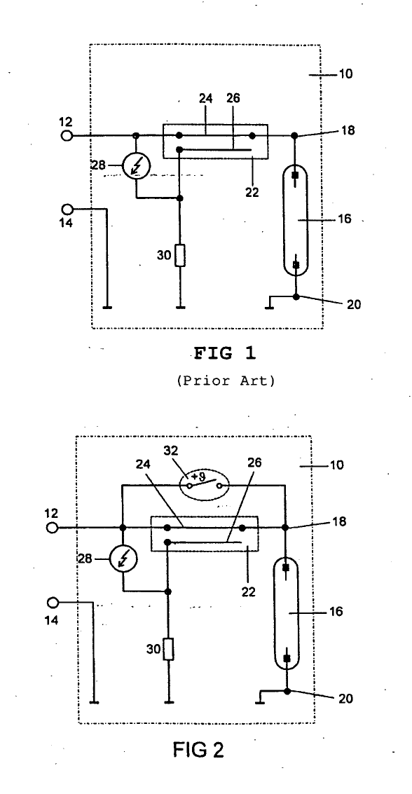

FIG. 2 shows the essential components, arranged in a lamp outer bulb 10, of a high-pressure discharge lamp according to the invention in an illustration similar to that in FIG. 1, with the same reference numerals being used for the same components.

The initial position was that a spiral pulse generator 22 was interposed between the input 12 of the lamp outer bulb 10 and the input 18 of the discharge vessel 16. The invention now provides a bimetallic switch 32, which closes in the event of an increase in the temperature and is connected in parallel with the spiral pulse generator 22 (more precisely to the first line path 24 thereof), i.e. is likewise interposed between the connection 12 of the lamp outer bulb 10 and the connection 18.

The spiral pulse generator is still used for igniting the lamp, i.e. the active gas located in the discharge vessel 16. This is described more precisely in DE 10 2005 061 832, with a subsequent publication date. The closing bimetallic switch 32 is active after the ignition if, owing to the operation of the lamp, the temperature in the lamp outer bulb 10 increases. If the closing temperature of the bimetallic stwitch 32 is reached, said bimetallic switch closes and prevents the operating current flowing via the discharge vessel (from the connection 12 to the connection 14 of the lamp outer bulb 10) from causing a considerable voltage drop, which brings about a power loss. The spiral pulse generator 22 provided merely for the ignition is therefore bypassed in the circuitry once its function has been performed. The high pressure discharge lamp from DE 10 2005 061 832, which has improved ignition capacity, is thereby further optimized.

1. A high-pressure discharge lamp with an outer bulb (10), on which a first connection (12) and a second connection (14) are provided, and with a discharge vessel (16) accommodated in the outer bulb (10) with a first and a second connection (18, 20) and with an ignition apparatus (22), which is accommodated in the outer bulb (10) and is connected between the first connection (12) of the outer bulb and the first connection (18) of the discharge vessel (16), characterized in that a switch (32) which closes as a function of temperature is connected in parallel with the ignition apparatus (22) between the first connection (12) of the outer bulb (10) and the first connection (18) of the discharge vessel (16).

2. The high-pressure discharge lamp as claimed in claim 1, the ignition apparatus being a spiral pulse generator (22).

3. The high-pressure discharge lamp as claimed in claim 1 or 2, characterized in that the switch which closes as a function of temperature is a bimetallic switch (32).

4. The high-pressure discharge lamp as claimed claim 1 or 2, characterized in that the switch (32) closes in the event of an increase in temperature to a closing temperature, which is between 70° C. and 500° C., preferably between 90° C. and 350° C.

5. A method for driving a high-pressure discharge lamp, in which ignition takes place by means of an ignition apparatus (22), which is arranged, together with a discharge vessel (16), in an outer bulb (10) of the high-pressure discharge lamp, characterized in that, after the ignition, a switch (32) is activated which guides the current required for operation of the high-pressure discharge lamp past the ignition apparatus (22).

6. The method as claimed in claim 5, characterized in
